(19) United States
(12) Patent Application Publication
(10) Pub. No.: US 2006/0289636 A1
(43) Pub. Date: Dec. 28, 2006

(54) Food card to restrict purchases

(76) Inventor: Robert S. Hoblit, Knightdale, NC (US)

Correspondence Address: MARCIA L. DOUBET LAW FIRM, P.O. BOX 422859, KISSIMMEE, FL, 34742-2589, US

(21) Appl. No.: 11/167,440

(22) Filed: Jun. 27, 2005

(51) Int. Cl. G06K 15/00; G06K 5/00

(52) U.S. Cl. 235/383; 235/380

(57) ABSTRACT

Restricted-purchase stored-value food cards which donors can purchase and donate, with assurance that purchases with those cards will be automatically restricted to particular food items (such as food items that would also qualify for food stamp benefits under a government program). Use of the food card to purchase items such as cigarettes and alcohol, for example, may be prohibited. By automatically restricting the purchases to eligible items, the donor's charitable intent can be fulfilled. The cards may be used by a shopper, for example, to supplement government food stamp benefits.

### BACKGROUND OF THE INVENTION

The present invention relates generally to “stored value” cards, and more particularly, to techniques for restricting purchases with such cards to food purchases.

Food stamps are provided through a program of the U.S. government to recipients that meet certain qualifications. A list of qualifying food items is established by the government, and the stamps can be exchanged for items from this list. Originally, booklets of stamps or coupons were provided to the recipients, and at the grocery check-out counter, stamps approximating the purchase price of the shopper's qualified food items were torn out of the booklet and surrendered to the grocery store.

The food stamp program has been enhanced in recent years to provide benefits electronically via a card-based program that uses an interface similar to that of debit cards, where a qualified recipient receives a card representing a particular monetary value and then presents this card at the point-of-sale, such that the purchase price of the qualified food items can be subtracted from the available balance represented by the card.

### BRIEF SUMMARY OF THE INVENTION

In one aspect, the present invention comprises providing restricted-purchase food card benefits by determining whether a shopper presenting a restricted-purchase food card for payment is eligible for use thereof, and if so, then: determining, for each item presented by the shopper for purchase, whether the presented item qualifies for payment using the food card, and if so, adding a cost of the presented item to an eligible amount; and using, for the payment of the eligible amount, at least a portion of a stored monetary value associated with the food card and reducing the stored monetary value by the used portion, wherein the food card is donated to the shopper such that the shopper can use the stored monetary value as payment for items that are automatically restricted to items qualifying for payment using the food card.

In another aspect, the present invention comprises enabling donors to donate food cards to shoppers while automatically restricting purchases made therewith to qualifying food items, comprising: enabling a donor to purchase a restricted-value food card for donation to a shopper, wherein the food card has a stored monetary value associated therewith and wherein the donor pays, as a purchase price of the food card, the stored monetary value; and enabling the shopper to use the donated food card to purchase qualifying food items, in an amount equal to the stored monetary value, such that the purchased food items are automatically restricted to food items from an eligibility list.

In yet another aspect, the present invention comprises a restricted-purchase food card, comprising a magnetic stripe readable by a magnetic stripe reader, the magnetic stripe encoded with information identifying the card as a restricted-purchase food card and with information from which an amount of available funds associated with the card can be determined, wherein the food card is adapted for use with payment processing that automatically restricts purchases made with the card to selected food items, such that a donor of the card can be assured that a shopper using the card for payment can only purchase the selected food items with the card.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIGS. 1A and 1B illustrate the front and back, respectively, of a sample stored-value restricted-purchase food card (referred to hereinafter as a “food card”) that may be used with embodiments of the present invention;

FIG. 2 provides a flowchart depicting logic that may be used when implementing one or more embodiments of the present invention;

FIG. 3 depicts a data processing system suitable for storing and/or executing program code; and

FIG. 4 depicts a sample communications network in which one or more embodiments of the present invention may be deployed.

### DETAILED DESCRIPTION OF THE INVENTION

Embodiments of the present invention enable private organizations and individuals to provide lower-income recipients with food items without the logistical issues and costs of purchasing and distributing the items. Traditional gift cards have been used to provide charitable gifts. However, use of the traditional cards is unrestricted, and recipients may thus use the gift cards for other than the intended charitable purpose. Using techniques disclosed herein, the charitable purpose can be achieved, whereby use of the gift cards is restricted to food purchases.

Private organizations and individuals can buy stored-value food cards, as such are disclosed herein, with assurance that purchases with those cards will be automatically restricted to particular food items (such as food items that would also qualify for food stamps under the government program). Use of the food card to purchase items such as cigarettes and alcohol, for example, may be prohibited. Since use of the card is restricted to qualified items, customers purchasing items preferably first present their food stamp identifying information to establish their eligibility for the food stamp program, and then present the food card disclosed herein to pay for the qualified items. (Different operating rules will typically apply for purchases made with the food card, as contrasted to purchases made using food stamps, since purchases made with food stamps are exempt from sales tax while purchases made using the private food cards disclosed herein would not be tax exempt.)

In one approach, food cards may be branded with private retailer labels. For example, grocery chains might allow charitable donors to purchase food cards usable only in stores of that grocery chain. As one alternative approach, a more generic provider might supply the cards. For example, debit card companies might offer such cards for purchase, where these cards are usable in stores operated by any of a number of retailers. This latter approach is advantageous, for example, when the donor purchases a card in one geographical area and donates it to a family in another geographic area which may have different store brands than those in the donor's area.

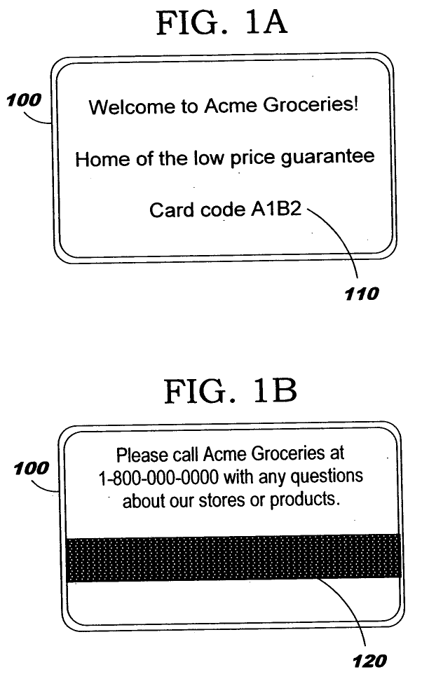

FIGS. 1A and 1B depict the front and back, respectively, of a sample stored-value food card 100 that may be used with embodiments of the present invention. Preferably, the card resembles a credit or debit card, and a magnetic stripe 120 (which may be located on the back of the card) is readable by magnetic stripe reader devices used to read credit and debit cards at a point-of-sale. The cards may be “loaded” with a monetary value using techniques known in the art for loading stored-value gift cards. For example, a code 110 may be provided on the card at the time of manufacture, such that the code can be read when the card is activated (e.g., upon its purchase by a donor) and thereby automatically assign a preset monetary value to the card. As another example, cards without a preset monetary value may be provided, such that the card's monetary value is established upon its purchase and activation. The magnetic stripe of the card may be passed through a card reader/write device, for example, which writes the monetary value into a predetermined area of the magnetic stripe. Other techniques may be used to establish the value associated with a particular card without deviating from the scope of the present invention. Furthermore, other information may optionally be encoded on the food card, if desired, such as an identification of the card purchaser. (Alternatively, however, the card purchaser may remain anonymous.)

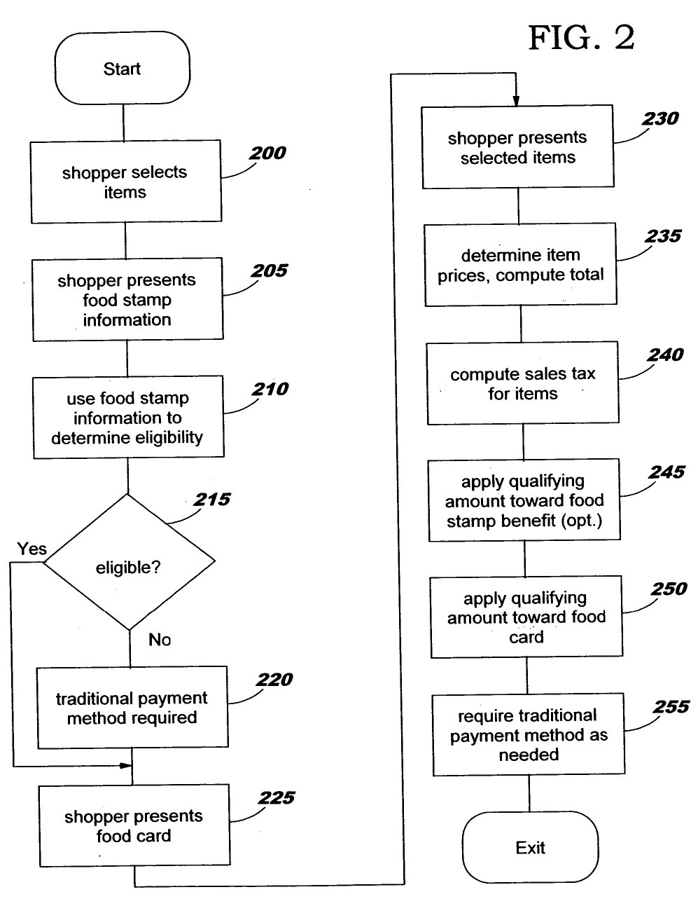

Referring now to FIG. 2, a flowchart is provided that depicts logic which may be used when implementing one or more embodiments of the present invention. A shopper selects some number of items (Block 200), for example by shopping in a grocery store or convenience store. When the shopper is ready to check out with the items, the shopper preferably presents credentials or other information usable for identifying this shopper as being eligible for the government food stamp program (Block 205). This information is then used (Block 210) to verify the shopper's food stamp eligibility. By verifying food stamp eligibility, preferred embodiments aim to combat fraudulent use of the food cards disclosed herein.

Block 215 tests whether the shopper is eligible for food stamps. If so, then control transfers to Block 225; otherwise, processing continues at Block 220. As indicated by Block 220, when the shopper is not eligible for food stamp benefits, preferred embodiments require the shopper to use a traditional payment method (such as cash, debit card, credit card, etc.), which effectively denies use of the stored-value food card. (Control may then exit from FIG. 2, or transfer to Block 230, if desired, rather than to Block 225.)

At Block 225, the shopper presents the stored-value food card, which is preferably read with a point-of-sale magnetic stripe reader device. Determining that a particular card read by a point-of-sale magnetic stripe reader is a food card may comprise checking a card sequence number against a list of sequence numbers maintained at a host system, where this list specifies (for example) the food cards which are valid at this retailer. In another approach, the retailer may assign card sequence numbers such that a particular range of card numbers are used only with food cards, and the card sequence number can then be evaluated to determine whether it falls within this range. As yet another approach, information encoded on the card's magnetic stripe may identify the card as a food card. Potentially, different approaches may be used by different retailers.

After presenting the food card, the shopper then presents the selected items for check-out (Block 230). (In one alternative approach, the shopper's food card and/or food stamp identifying information may be presented after the selected items have been presented for check-out, rather than before.) For each presented item, a price is determined (Block 235), and a total sales amount is computed. A sub-total of items eligible for food stamp benefits may be determined, for example, by comparing the item identifier of each presented item to a list of food-stamp-eligible item identifiers. One alternative technique to comparing item identifiers to a list comprises marking individual food (or grocery) items as to their eligibility (for example, by augmenting the item's machine-readable identifier with an eligibility flag or indicator). Another alternative technique comprises classifying food (or grocery) items, determining the class of a presented item, and then determining eligibility of the class associated therewith.

In Block 240, a sales tax total is computed for the selected items. Some items may be exempt from sales tax, and items purchased using government food stamps are not subject to sales tax. However, because the food cards disclosed herein are not distributed under a government program, taxable items will typically require tax to be paid (for example, by including the tax in the amount subtracted from the value of the food card).

Optionally, the shopper may use a combination of payment methods, such as food stamps and a food card, to pay for the selected items. Accordingly, Block 245 indicates that some qualifying portion of the total sales amount may be applied toward the shopper's food stamp benefits.

An amount that qualifies for purchase using the stored-value food card is applied to the food card (Block 250), thereby reducing the stored value of the card. As discussed earlier, this qualifying amount should be limited to food items that fulfill the donor's charitable purpose (such as items that meet the criteria for payment under the government food stamp program.) The card balance is preferably stored at a host, and a message is preferably sent to the host from a point-of-sale device where the card is read to determine the available finds on the card, and to update the card balance. (If the available funds on the shopper's card are insufficient for full payment of eligible items, the shopper may choose to use another payment method such as cash or check, or perhaps food stamp benefits as discussed with reference to Block 245.)

One or more traditional payment methods may be used (Block 255) to pay for items that do not meet the criteria for the food card or the shopper's food stamp benefits (when applicable). The processing of FIG. 2 then exits.

When the shopper uses a combination of payment methods, as discussed above, the amount to be applied to the food card versus the amount to be paid for using another method (including food stamps) may be determined in various ways. In one approach, the user may be asked for an upper limit on the amount to be paid using the food card. It may be desirable to give preference to exhausting the shopper's food stamp benefits before applying any remaining balance of qualified items toward the food card.

While the processing of FIG. 2 describes limiting use of food cards to shoppers who demonstrate their eligibility for the government food stamp program, this is by way of illustration and not of limitation. In one alternative approach, food cards may be provided to recipients that are of low income even though the recipient does not necessarily qualify for food stamp benefits.

Optionally, one or more embodiments of the present invention may support use of rechargeable or reloadable food cards—that is, cards that have an initial monetary value loaded thereupon at the time of activation, and that allow additional funds to be loaded onto the same card at a later time. One manner in which this may be accomplished is to use a card that is separable into multiple portions (or which is initially provided as multiple portions), such that the donor keeps a portion of the card that is uniquely associated with the portion given to the recipient. The donor can then present the portion he or she kept, to be read at a point-of-sale by a magnetic stripe reader. Upon locating an identifier on the portion read by the magnetic stripe reader, the available balance for the associated food card can then be increased.

Providers of the food cards described herein may be individuals or charitable groups, as has been discussed. As one alternative, funds may be provided by individuals or charitable groups to agencies that will then purchase the actual cards and distribute them to families. (It should be noted that reference to “families” and “shoppers” herein is by way of illustration, and is not intended to limit use of the present invention to donating food cards to particular groups or types of people.)

Optionally, network transaction processing fees may be applied for use of food cards, similar to fees charged for use of debit and credit cards. Leveraging existing food stamp logic in point-of-sale applications may serve to keep implementation overhead relatively low.

As will be appreciated by one of skill in the art, selected components of the present invention may be provided as methods, systems, and/or computer program products comprising computer-readable program code. Accordingly, components of the present invention may be embodied in hardware/firmware. An embodiment combining software and hardware aspects, or an embodiment in software only, might be used alternatively.

Furthermore, components of the invention may take the form of a computer program product accessible from computer-usable or computer-readable media providing program code for use by, or in connection with, a computer or any instruction execution system. For purposes of this description, a computer-usable or computer-readable medium can be any apparatus that can contain, store, communicate, propagate, or transport a program for use by, or in connection with, the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, removable computer diskette, random access memory (“RAM”), read-only memory (“ROM”), rigid magnetic disk, and optical disk. Current example of optical disks include compact disk with read-only memory (“CD-ROM”), compact disk with read/write (“CD-R/W”), and DVD.

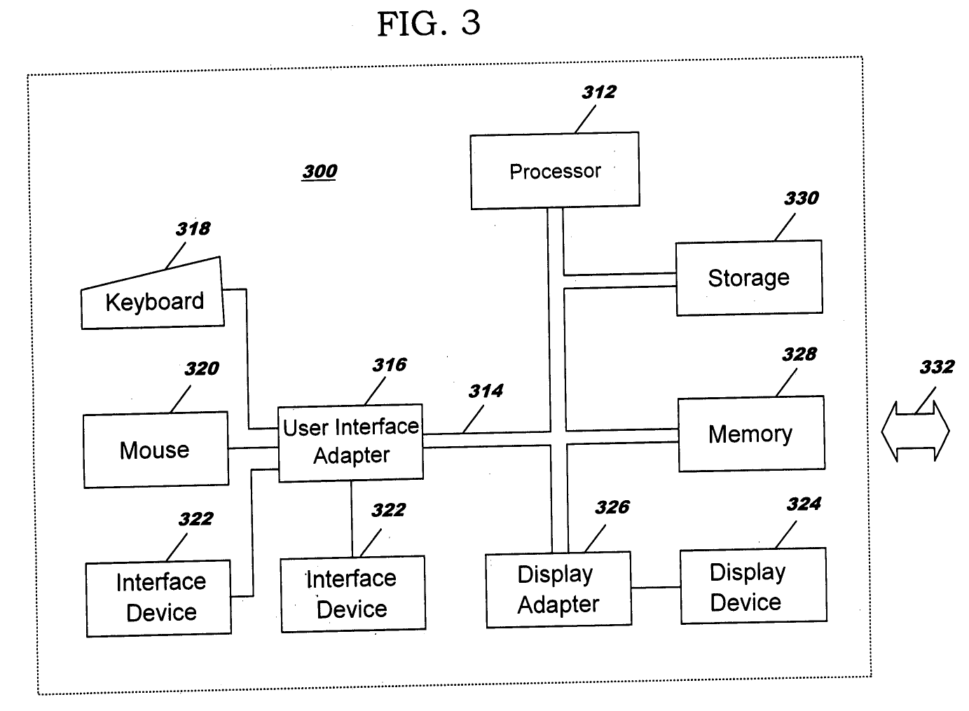

Referring now to FIG. 3, a data processing system 300 suitable for storing and/or executing program code includes at least one processor 312 coupled directly or indirectly to memory elements through a system bus 314. The memory elements can include local memory 328 employed during actual execution of the program code, bulk storage 330, and cache memories (not shown) which provide temporary storage of at least some program code in order to reduce the number of times code must be retrieved from bulk storage during execution.

Input/output (I/O”) devices (including but not limited to keyboards 318, displays 324, pointing devices 320, other interface devices 322, etc.) can be coupled to the system either directly or through intervening I/O controllers or adapters (316, 326).

Network adapters may also be coupled to the system to enable the data processing system to become coupled to other data processing systems or remote printers or storage devices through intervening private or public networks (as shown generally at 332). Modems, cable modem attachments, wireless adapters, and Ethernet cards are just a few of the currently-available types of network adapters.

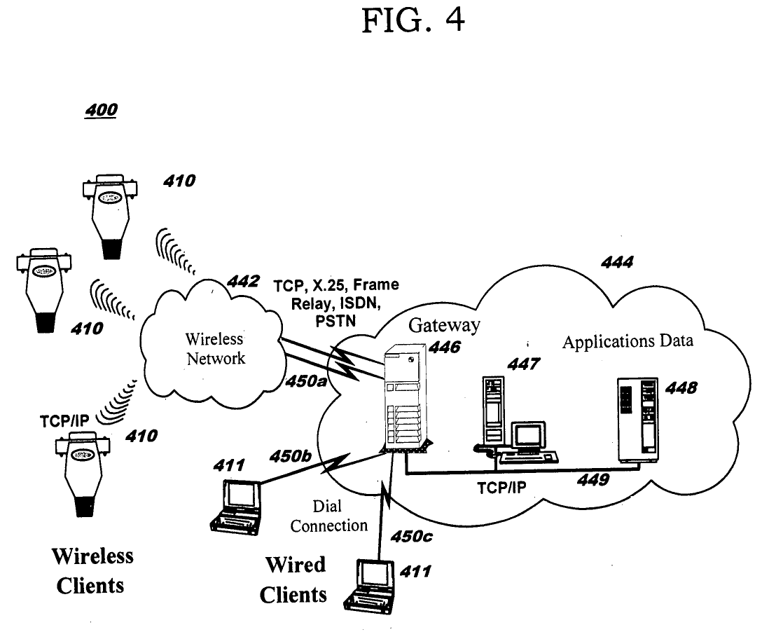

FIG. 4 illustrates a sample communications network in which one or more embodiments of the present invention may be deployed. The data processing network 400 may include a plurality of individual networks, such as wireless network 442 and network 444. A plurality of magnetic stripe reader devices 410 (as well as other devices, not shown) may communicate over wireless network 442, and a plurality of devices, shown in the figure (by way of illustration) as workstations 411, may communicate over network 444. Additionally, as those skilled in the art will appreciate, one or more local area networks (“LANs”) may be included (not shown), where a LAN may comprise a plurality of devices coupled to a host processor.

Still referring to FIG. 4, the networks 442 and 444 may also include mainframe computers or servers, such as a gateway computer 446 or application server 447 (which may access a data repository 448). A gateway computer 446 serves as a point of entry into each network 444. The gateway 446 may be preferably coupled to another network 442 by means of a communications link 450a. The gateway 446 may also be directly coupled to one or more workstations 411 using a communications link 450b, 450c, and/or may be indirectly coupled to such devices. The gateway computer 446 may be implemented utilizing an Enterprise Systems Architecture/370™ available from the International Business Machines Corporation (“IBM®”), an Enterprise Systems Architecture/390® computer, etc. Depending on the application, a midrange computer, such as an Application System/400® (also known as an AS/400®) may be employed. (“Enterprise Systems Architecture/370” is a trademark of IBM; “IBM”, “Enterprise Systems Architecture/390”, “Application System/400”, and “AS/400” are registered trademarks of IBM.)

The gateway computer 446 may also be coupled 449 to a storage device (such as data repository 448).

Those skilled in the art will appreciate that the gateway computer 446 may be located a great geographic distance from the network 442, and similarly, the magnetic stripe reader devices 410 and/or workstations 411 may be located some distance from the networks 442 and 444, respectively. For example, the network 442 may be located in California, while the gateway 446 may be located in Texas, and one or more of the workstations 411 may be located in Florida. The magnetic stripe reader devices 410 may connect to the wireless network 442 using a networking protocol such as the Transmission Control Protocol/Internet Protocol (“TCP/IP”) over a number of alternative connection media, such as cellular phone, radio frequency networks, satellite networks, etc. The wireless network 442 preferably connects to the gateway 446 using a network connection 450a such as TCP or User Datagram Protocol (“UDP”) over IP, X.25, Frame Relay, Integrated Services Digital Network (“ISDN”), Public Switched Telephone Network (“PSTN”), etc. The magnetic stripe reader devices 410 and/or workstations 411 may connect directly to the gateway 446 using dial connections 450b or 450c. Further, the wireless network 442 and network 444 may connect to one or more other networks (not shown), in an analogous manner to that depicted in FIG. 4.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention. Furthermore, it should be understood that use of “a” or “an” in the claims is not intended to limit embodiments of the present invention to a singular one of any element thus introduced.

1. A method of providing restricted-purchase food card benefits, comprising steps of:
determining whether a shopper presenting a restricted-purchase food card for payment is eligible for use thereof, and if so, performing steps of:
determining, for each item presented by the shopper for purchase, whether the presented item qualifies for payment using the food card, and if so, adding a cost of the presented item to an eligible amount; and
using, for the payment of the eligible amount, at least a portion of a stored monetary value associated with the food card and reducing the stored monetary value by the used portion,
wherein the food card is donated to the shopper such that the shopper can use the stored monetary value as payment for items that are automatically restricted to items qualifying for payment using the food card.

2. The method according to claim 1, wherein the food card is purchased and donated by a private donor.

3. The method according to claim 1, wherein the step of determining whether the shopper is eligible for use of the food card further comprises the step of verifying that the shopper is eligible for food stamp benefits.

4. The method according to claim 3, wherein the step of verifying that the shopper is eligible for food stamp benefits further comprises using a food stamp card presented by the shopper.

5. The method according to claim 3, wherein the step of verifying that the shopper is eligible for food stamp benefits further comprises using food stamp identifying information presented by the shopper.

6. The method according to claim 1, wherein the step of determining whether the presented item qualifies for payment using the food card further comprises the step of concluding that the presented item qualifies for the payment only if the presented item is eligible for food stamp benefits.

7. The method according to claim 1, wherein the step of determining whether the presented item qualifies for payment using the food card further comprises the steps of:
determining a class of the presented item; and
concluding that the presented item qualifies if the class is eligible for food stamp benefits.

8. The method according to claim 1, wherein the step of determining whether the presented item qualifies for payment using the food card further comprises the steps of:
comparing an identifier of the presented item to a list of eligible items; and
if the identifier for the presented item appear on the list, concluding that the presented item qualifies.

9. The method according to claim 1, wherein the step of determining whether the presented item qualifies for payment using the food card further comprises the step of checking an eligibility indicator encoded in machine-readable information of the presented item.

10. The method according to claim 1, wherein the food card is rechargeable, such that the stored monetary value associated with the card can be increased subsequent to an initial activation of the card.

11. The method according to claim 1, wherein the food card is rechargeable, such that the stored monetary value associated with the card can be increased subsequent to reducing the stored monetary value at least once.

12. The method according to claim 1, wherein the stored monetary value is predetermined for the food card.

13. The method according to claim 1, wherein the stored monetary value is determined by a donor who donates the food card to the shopper.

14. A method of enabling donors to donate food cards to shoppers while automatically restricting purchases made therewith to qualifying food items, comprising steps of:
enabling a donor to purchase a restricted-value food card for donation to a shopper, wherein the food card has a stored monetary value associated therewith and wherein the donor pays, as a purchase price of the food card, the stored monetary value; and
enabling the shopper to use the donated food card to purchase qualifying food items, in an amount equal to the stored monetary value, such that the purchased food items are automatically restricted to food items from an eligibility list.

15. A restricted-purchase food card, comprising a magnetic stripe readable by a magnetic stripe reader, the magnetic stripe encoded with information identifying the card as a restricted-purchase food card and with information from which an amount of available funds associated with the card can be determined, wherein the food card is adapted for use with payment processing that automatically restricts purchases made with the card to selected food items, such that a donor of the card can be assured that a shopper using the card for payment can only purchase the selected food items with the card.

16. The restricted-purchase food card according to claim 15, wherein the selected food items are determined by consulting a stored list of food items for which food stamp benefits are available.

17. A computer program product for providing restricted-purchase food card benefits, the computer program product comprising computer-readable code embodied on one or more computer-usable media, the computer-readable code comprising instructions that when executed on a computer cause the computer to:
determine whether a shopper presenting a restricted-purchase food card for payment is eligible for use thereof, and if so, to:
determine, for each item presented by the shopper for purchase, whether the presented item qualifies for payment using the food card, and if so, adding a cost of the presented item to an eligible amount; and
use, for the payment of the eligible amount, at least a portion of a stored monetary value associated with the food card and reduce the stored monetary value by the used portion,
wherein the food card is donated to the shopper by a donor, such that the shopper can use the stored monetary value as payment for items that are automatically restricted to items qualifying for payment using the food card.

18. The computer program product according to claim 17, wherein the instructions that cause the computer to determine whether the shopper is eligible for use of the food card further comprise instructions for causing the computer to verify that the shopper is eligible for food stamp benefits using food stamp identifying information presented by the shopper.

19. The computer program product according to claim 17, wherein the instructions that cause the computer to determine whether the presented item qualifies for payment using the food card further comprise instructions for causing the computer to conclude that the presented item qualifies for the payment only if the presented item is eligible for food stamp benefits.

20. The computer program product according to claim 17, wherein the donor is a private individual or a private charitable group.
